(19) United States
(12) Patent Application Publication
(10) Pub. No.: US 2024/0111756 A1
(43) Pub. Date: Apr. 4, 2024

(54) Communications Interface Between Separate Systems Referencing Distributed Ledger

(71) Applicant: SAP SE, Walldorf (DE)

(72) Inventor: Frank Albrecht, Walldorf (DE)

(21) Appl. No.: 17/959,759

(22) Filed: Oct. 4, 2022

(51) Int. Cl. G06F 16/23

(52) U.S. Cl. CPC G06F 16/2379

(57) ABSTRACT

Embodiments utilize distributed ledger technology (e.g., blockchain) to handle interaction flows for processes occurring between separate/distinct systems. A first system initiates an interaction flow, creating a first ledger entry (e.g., blockchain transaction) based upon an original timestamp and encryption keys. The interaction flow is then communicated across a boundary of the first system to a second system. The second system receives the interaction flow, and creates a second ledger entry (e.g., second blockchain transaction in the blockchain) based upon a subsequent timestamp and hash of the first ledger entry. Further cross-system interactions are similarly handled by creating additional immutable ledger entries (e.g., more blockchain transactions in the blockchain). Thus, the stored interaction flows serve as the single source of truth for communication across system boundaries. This allows verification of cross-system communications without resort to a central authority, and moreover can serve as the basis for analytical querying regarding cross-system interaction.

### BACKGROUND

Unless otherwise indicated herein, the approaches described in this section are not prior art to the claims in this application and are not admitted to be prior art by inclusion in this section.

With the evolution of cloud computing, separate computer systems increasingly communicate messages with one another. Ensuring the security and verifiability of that communication can pose a challenge, as different systems have different security measures (such as firewalls).

In certain environments, the different systems implement message handing independently. That is, each system may only indicate that a message is sent and/or received.

Such independent message handling can undesirably lead to a different “truth” in each system regarding message handling. For example, a Company 1 may assume that a particular message was sent to Company 2, while Company 2 assumes that it never in fact received the message.

### SUMMARY

Embodiments utilize distributed ledger technology (e.g., blockchain) to handle interaction flows for processes occurring between separate and distinct systems. A first system initiates an interaction flow, creating a first ledger entry (e.g., blockchain transaction) that is based upon an original timestamp and encryption keys. The interaction flow is then communicated across a boundary of the first system to a second system. The second system receives the interaction flow, and creates a second ledger entry (e.g., second blockchain transaction in the blockchain) based upon a subsequent timestamp and hash of the first ledger entry. Further cross-system interactions are similarly handled by creating additional immutable ledger entries (e.g., more blockchain transactions in the blockchain). In this manner, the stored interaction flows serve as the single source of truth for communication across system boundaries. This allows verification of cross-system communications without resort to a central authority, and moreover can serve as the basis for analytical querying regarding cross-system interaction.

The following detailed description and accompanying drawings provide a better understanding of the nature and advantages of various embodiments.

### BRIEF DESCRIPTION OF THE DRAWINGS

FIG. 1 shows a simplified diagram of a system according to an embodiment.

FIG. 1A shows a simplified flow diagram of a method according to an embodiment.

FIG. 2 offers an overview of a blockchain distributed ledger system.

FIG. 3 shows an overview of system interactions according to a first example relating to invoicing.

FIG. 4 shows an overview of an interface standard according to a first example.

FIG. 5 shows an interface for a first company in the first example.

FIG. 6 shows an interface for a second company in the first example.

FIGS. 7-10 show various interactions occurring according to the first example.

FIG. 11 shows an interaction history according to the first example.

FIGS. 12A-B show an overview of system interactions according to a second example relating to vehicle charging.

FIGS. 13-17 shows ledger information for the second example.

FIG. 18 shows a sample screenshot in the second example.

FIGS. 19-22 show more ledger information for the second example.

FIG. 23 illustrates hardware of a special purpose computing machine configured to implement a communications interface according to an embodiment.

FIG. 24 illustrates an example computer system.

### DETAILED DESCRIPTION

Described herein are methods and apparatuses that implement a communications interface between separate and distinct systems. In the following description, for purposes of explanation, numerous examples and specific details are set forth in order to provide a thorough understanding of embodiments according to the present invention. It will be evident, however, to one skilled in the art that embodiments as defined by the claims may include some or all of the features in these examples alone or in combination with other features described below, and may further include modifications and equivalents of the features and concepts described herein.

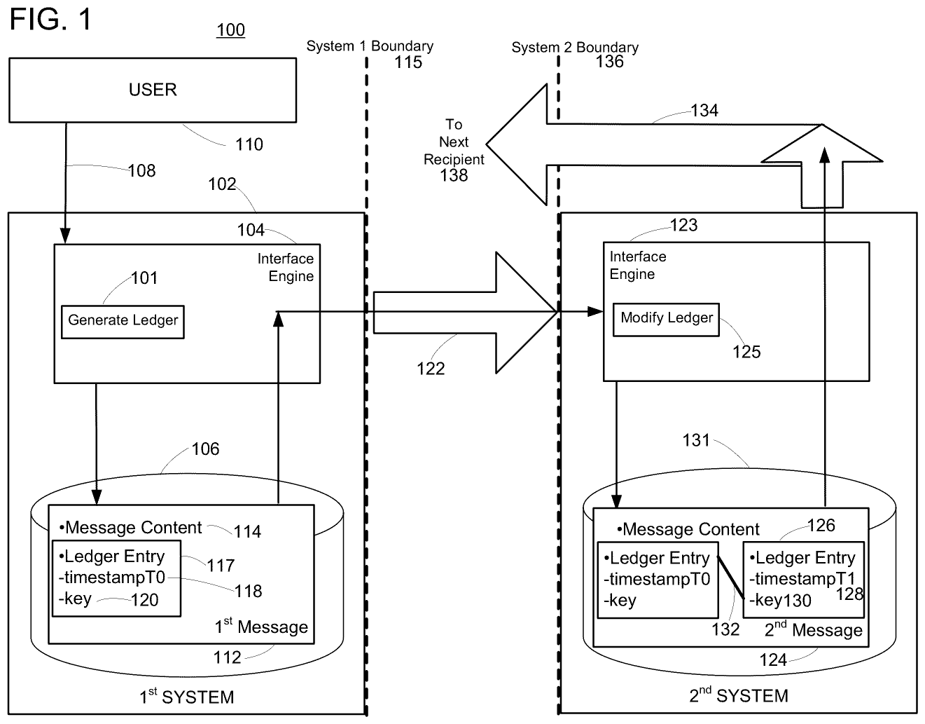

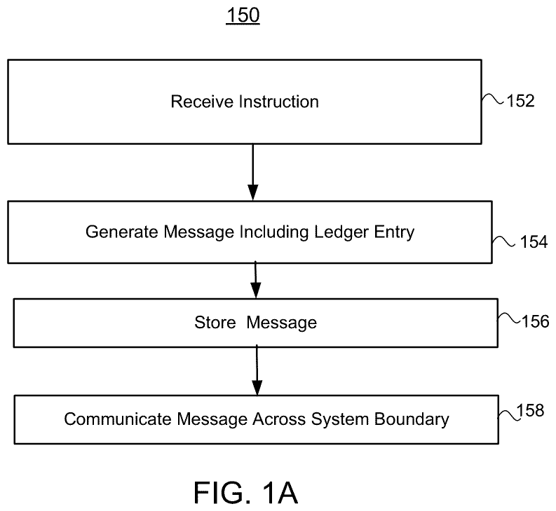

FIG. 1 shows a simplified view of an example system that is configured to implement a communications interface between separate systems according to an embodiment.

Specifically, system 100 comprises a first system 102 including an interface engine 104 in communication with a non-transitory computer readable storage medium 106. The first system receives an instruction 108 from a user 110 to communicate a 1s′ message 112 including content 114, outside of the first system across system boundary 115 to a second system 116.

Accordingly, the interface engine initiates an interaction flow by generating 101 a first ledger entry 117 and storing same in the medium 106. The ledger entry comprises an initial timestamp (time TO) 118 and a key 120. Then, the interface engine sends 122 the first message to the second system across the system boundary, which may be defined, e.g., by a firewall.

The second system receives the first message. The interface engine 123 of the second system generates a second message 124 from the first message. In particular, the interface engine of the second system modifies 125 the ledger to include a second ledger entry 126 with a second timestamp 128 (time Ti, subsequent to TO) and a key 130. The second ledger entry is stored in the second storage medium 131, with a link 132 to the first ledger entry (e.g., by a hash).

The second system is then able to communicate 134 the second message across the second message boundary 136 to a recipient located outside of the second system. (That recipient may—or may not be—the first system). By referencing the (evolving) ledger of the message, the recipient is able to trust the authenticity of the incoming message without having to reference some central source in order to establish a truth.

FIG. 1A is a flow diagram of a method 150 according to an embodiment. At 152, an instruction is received to communicate a message outside of a system.

In response to the instruction, at 154 a message comprising content and also a ledger entry including a first timestamp and a key, is generated. At 156, the message is stored in a non-transitory computer readable storage medium.

At 158 the message including the ledger entry is communicated across a boundary of the system to a recipient.

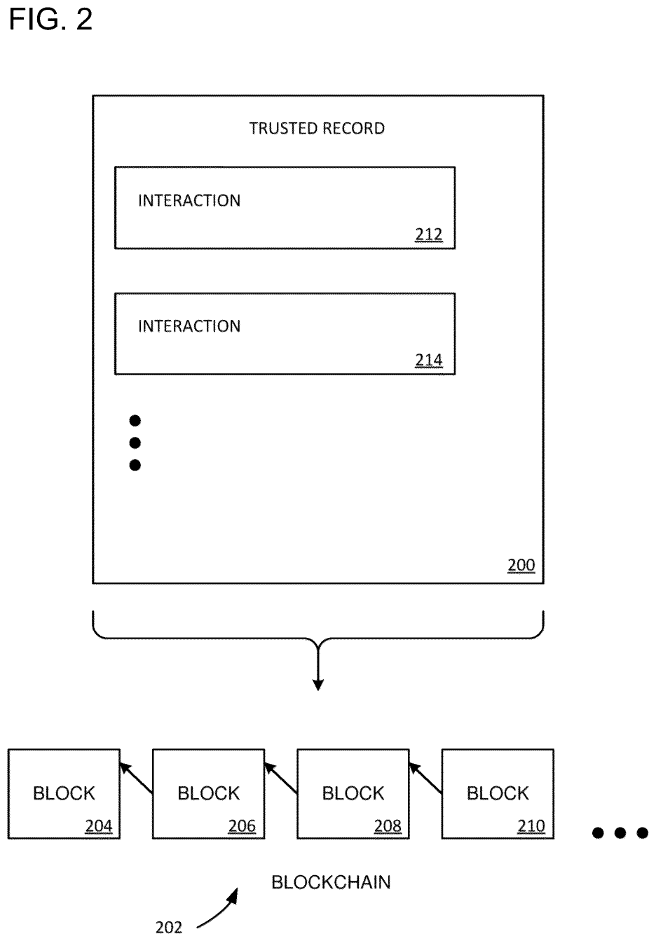

Blockchain is one specific form of a distributed ledger which may be used to implement a communications interface according to various embodiments. FIG. 2 illustrates an example trusted record 200 stored in a blockchain 202. As used herein, “blockchain” refers to a distributed storage platform and network in which individual “blocks” are connected in a chain. Blocks are stored on nodes, which can be various distributed computing devices.

Each block is linked to the previous block in the blockchain by, for example, including a hash of the previous block. Various hash functions, including functions in the Secure Hash Algorithm (SHA)-1 or -2 families (such as SHA-256), can be used to perform a one-way hash.

For a one-way hash, it is generally considered to be impossible or impractical to generate the input (the “message”) to the hash function based on the output (the “message digest” or “digest”) of the hash function. In FIG. 2, blocks 204, 206, 208, and 210 form blockchain 202 that stores trusted record 200.

Trusted record 200 includes interactions 212 and 214. Interactions 212 and 214 can include an interaction type (e.g., “create record,” “view record,” “update record,” etc.), together with a timestamp and an identifier for the interacting application.

In some embodiments, public keys (e.g., for use with a blockchain wallet) are assigned to the respective applications. The public key of the interacting application is stored in interactions 212 and 214 in trusted record 200.

Blockchain 202 can be implemented using a number of blockchain frameworks, including MultiChain. MultiChain is a platform used to establish private blockchains that has an API and a command line interface.

Another blockchain framework is Hyperledger Fabric. Hyperledger Fabric is a modular blockchain framework that acts as a foundation for developing blockchain-based products, solutions, and applications.

Still another possible blockchain framework is Quorum. Quorum allows entities to leverage Ethereum for blockchain applications.

Embodiments of interfaces as disclosed herein may offer one or more benefits. Specifically, absent such an interface, each party ends up storing their own truth. If those truths differ as between the parties, additional effort and cost may be needed in order to establish a single truth that is agreed to by all parties.

Another possible benefit offered by embodiments is universality. That is, an interface can offer a standard as a starting point for a new market, where parties offer specific interfaces for particular cross-party processes. One example of such processes could be the issuance of invoices and their payment, as is described below.

Interface embodiments may also offer the benefit of a low barrier to entry. In particular, parties need only to implement the interaction with the common interface, rather than having to explicitly integrate their separate systems via distinct APIs.

Embodiments of interfaces may offer the benefit of relatively loose coupling. That is, utilizing an interface according to an embodiment may avoid having to perform a complex, expensive, and potentially error prone integration of separate systems to react to changes in those different systems.

Embodiments may also offer the benefit of simplicity. For example, mapping of IDs may not be needed in a process where all parties refer to the Id of a single, common, interface.

Further details regarding the implementation of a communications interface between separate systems according to various embodiments, are now provided in connection with the following examples. These examples utilize the Business Process Model and Notation (BPMN) 2.0 standard. In these examples, the interface is referred to as an Honest Broker (H-Broker).

### Examples

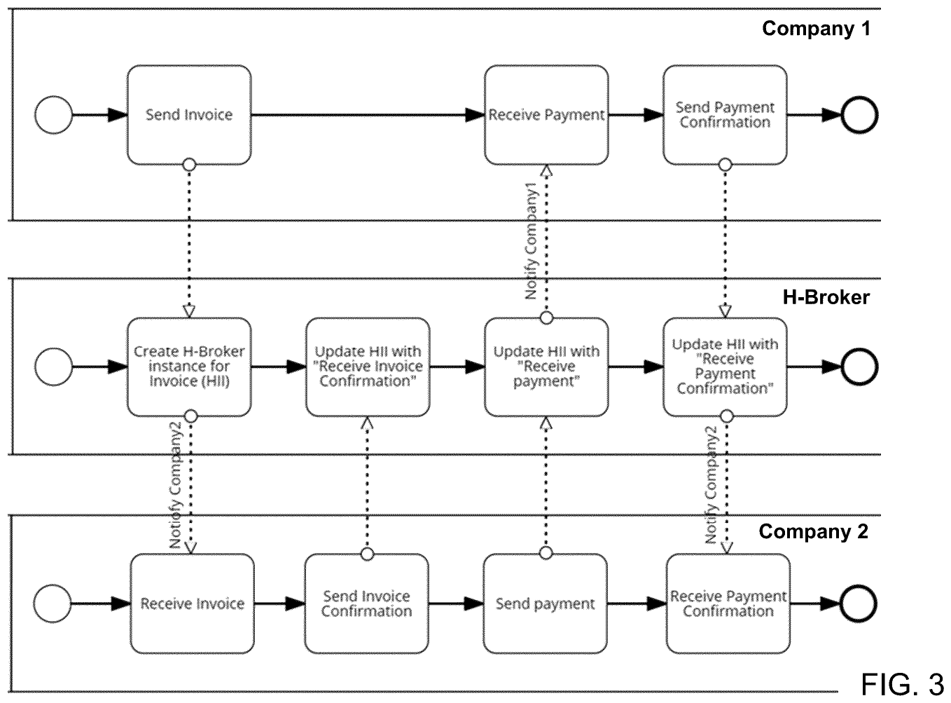

FIG. 3 shows a simplified view of a first example wherein an H-Broker interface is between two separate systems (Company 1; Company 2). In this particular example, a cross-Company process involves Company 1 sending an invoice to Company 2, with Company 2 paying the invoice and Company 1 receiving the payment.

Embodiments offer interaction flows that can be used for processes crossing company boundaries. These interaction flows are stored in an honest interface, acting as a single source of truth for the separate companies involved in the cross-company processes.

In FIG. 3, the interface acts like a man-in-the-middle. Company 1 and Company 2 interact with the interface, and the interface stores interactions and sets a timestamp for each interaction. Using Public-/Private-Key encryption, there is no need for the companies to onboard to a centralized interface.

The specific example of FIG. 3 involves the following cross-company processes:
Company 1: invoice sent
Company 2: invoice received
Company 2: payment sent
Company 1: payment received

These example cross-company processes result in the following interactions with the interface:
Company 1
   Interaction {timestamp=2021-12-16T15:29:19.839729300, info=‘create new H-Broker’}
Company 1
   Interaction {timestamp=2021-12-16T15:29:19.849731500, info=‘invoice sent’}
Company 2
   Interaction {timestamp=2021-12-16T15:29:19.849731500, info=‘invoice received’}
Company 2
   Interaction {timestamp=2021-12-16T15:29:19.849731500, info=‘payment sent’}
Company 1
   Interaction {timestamp=2021-12-16T15:29:19.849731500, info=‘payment received’} Details regarding interaction flows are provided below.
1. Company 1 interacts with the H-Broker. As this is the first interaction, a new H-Broker is created with the interaction:
“Created By Company1 at date1”.
2. Company 2 receives the ID of the H-Broker, performs the payment, and interacts with the H-Broker:
“Payed by Company2 at date2”.
3. Company 1 receives the update of the H-Broker, and approves the Payment:
“Payment Approved by Company1 at date3”.

Whenever Company 1 and Company 2 need to discuss the nature of the invoice/payment exchange, they can query the H-Broker in order to obtain a definitive history of interactions as the single-source of truth.

Implementation options of an H-Broker are now discussed. At least two capabilities may be used to implement the H-Broker in this example.
1) Blockchain capabilities are used to manage an immutable ledger. This covers the “H” (Honest) part of the H-Broker.
2) Decentralized storage of information is used. In a central world, access to information is via the system that manages the information. By contrast, in the decentralized world, the information itself provides access.

Specific implementation of one possible prototype of the H-Broker is now discussed. The SAP BTP Canary landscape available from SAP SE of Walldorf, Germany, offers the SAP HANA Shared Ledger service. That service can be leveraged in order to implement an H-Broker which is used by the interaction flow.

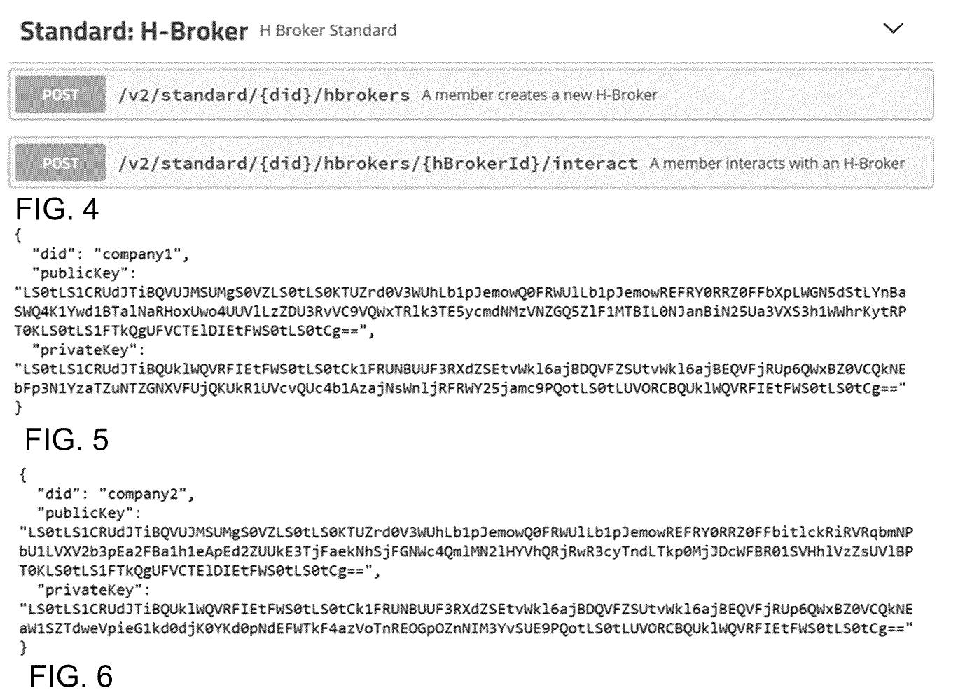

Each company has a Public Key/Private Key-pair which is used to store the interactions in the H-Broker. To simplify the prototype, the Public-/Private key pair is managed centrally. And, each company has a “did” which they use to interact with the H-Broker. FIG. 4 shows an overview of the H-Broker standard of this example.

Creation of the did of Company1 and Company2 is now discussed. The dids are company1 and company2.

When creating a did, a Public Key/Private Key pair is created. The Public Key identifies the company in the H-Broker. Only the owner of the Private Key can sign messages with the Public Key.

In this particular example, the Public Key of Company 1 is:
LS0tLS1CRUdJTiBQVUJMSUMgS0VZLS0tLS0KTUZrd0V3WUhLb1pJemowQ0FRWU1L b1pJemowREFRY0RRZ0FFMktqeXVrM01XVE1y0HV1NG05MGt2NmFtTkttagpjcXBKeD ZrVEc0Um5GUnpsTzBhWmVrUUQ0TEdjZkk2WnVDaE0vSysxVFNSOEtzUHN1UHBxTE 5pQW53PT0KLS0tLS1FTkQgUFVCTE1DIEtFWS0tLS0tCg==

In this particular example, the Public Key of Company 2 is:
LS0tLS1CRUdJTiBQVUJMSUMgS0VZLS0tLS0KTUZrd0V3WUhLb1pJemowQ0FRWU1L b1pJemowREFRY0RRZ0FFMFpSbUZabjhyaG5CTGh3L1VOMXJ2U3hoaENObgpsM1pBa DBIOVo2b0QwYW1MOGYzSDVQM1p4U0xWVjVmNno3S0hmU25jcWVTc1pqeUZLS0RIQT1vY1NBPT0KLS0tLS1FTkQgUFVCTE1DIEtFWS0tLS0tCg==

FIG. 5 shows the corresponding H-Broker of Company 1. FIG. 6 shows the corresponding H-Broker of Company 2.

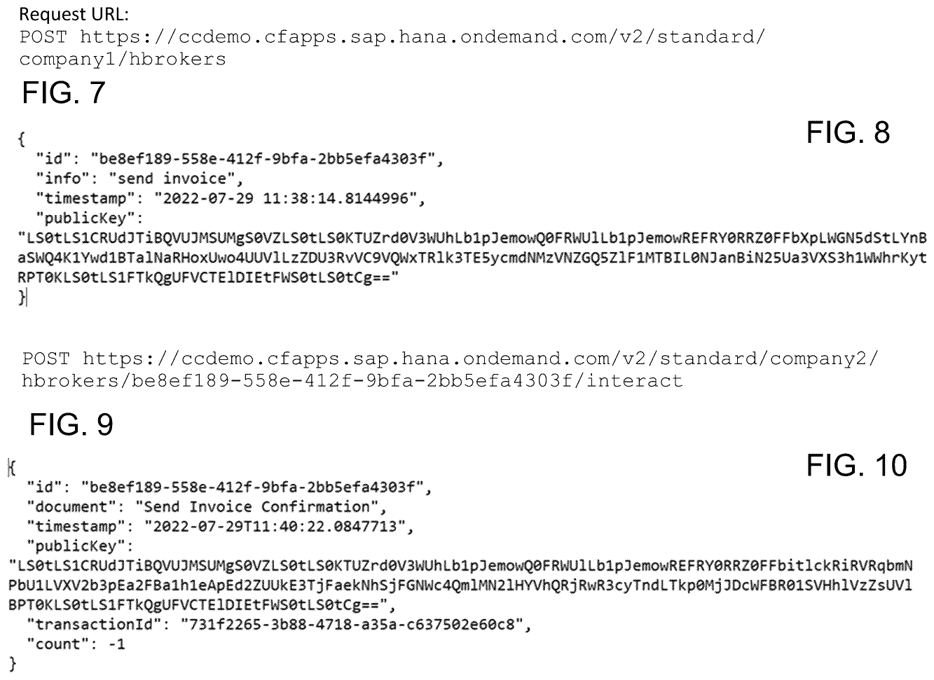

Interaction with the H-Broker to initiate the process of the first example is now discussed. Company 1 starts the process by “send invoice”. This is accomplished by sending a POST request to the H-Broker with the “send invoice” information. This request is shown in FIG. 7.

FIG. 8 shows the response of the H-Broker. This response includes:
the H-Broker id: 4cb6369b-616d-4fd4-973a-c92f3d3c712b,
the information (“send invoice”),
the Public Key of Company 1, and
the timestamp created by the H-Broker.

Interaction with the H-Broker to continue the process of the first example is now discussed. These following process steps are aware of the H-Broker Id and interact with the H-Broker.

Company 2 sends the invoice confirmation shown in FIG. 9.

FIG. 10 shows the response of the H-Broker. That response includes:
the H-Broker id: 4cb6369b-616d-4fd4-973a-c92f3d3c712b,
the information (“Send Invoice Confirmation”),
the Public Key of Company 2, and
the timestamp created by the H-Broker.

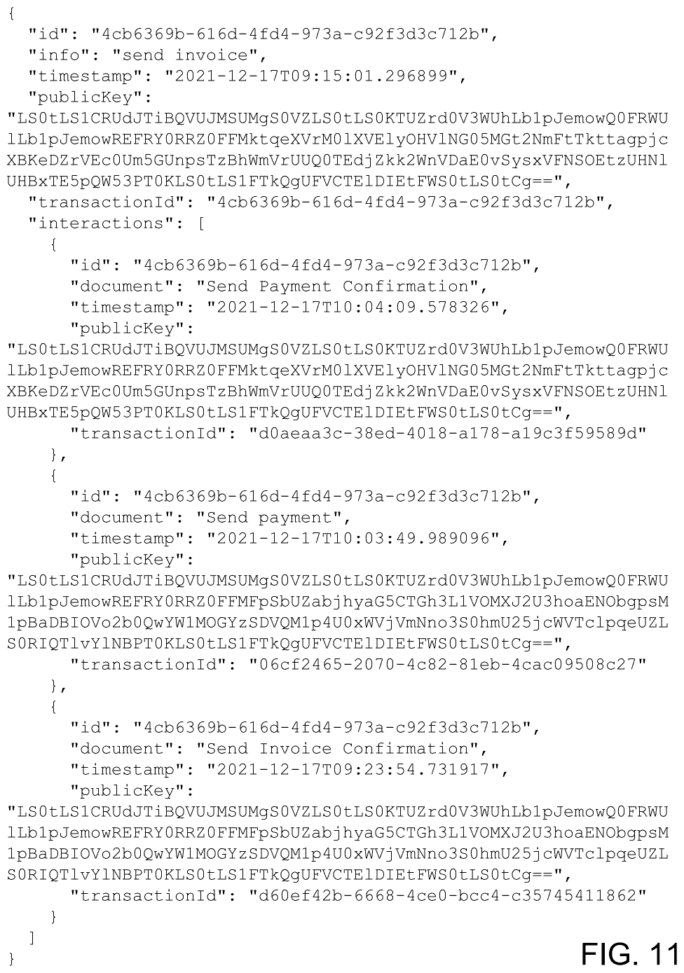

As a result, once the process is completed, the H-Broker contains the interaction history. That interaction history is shown in FIG. 11. The transactionId refers to Blockchain transactions.

Another example of an embodiment of an interface between separate systems, is now described in connection with the charging of an electric vehicle. In this particular example, three (rather than only two) separate systems interact with the honest interface.

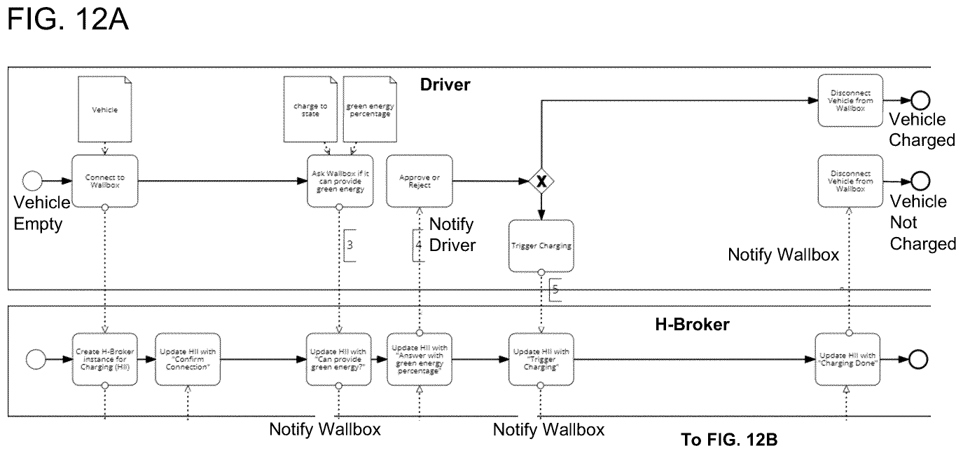

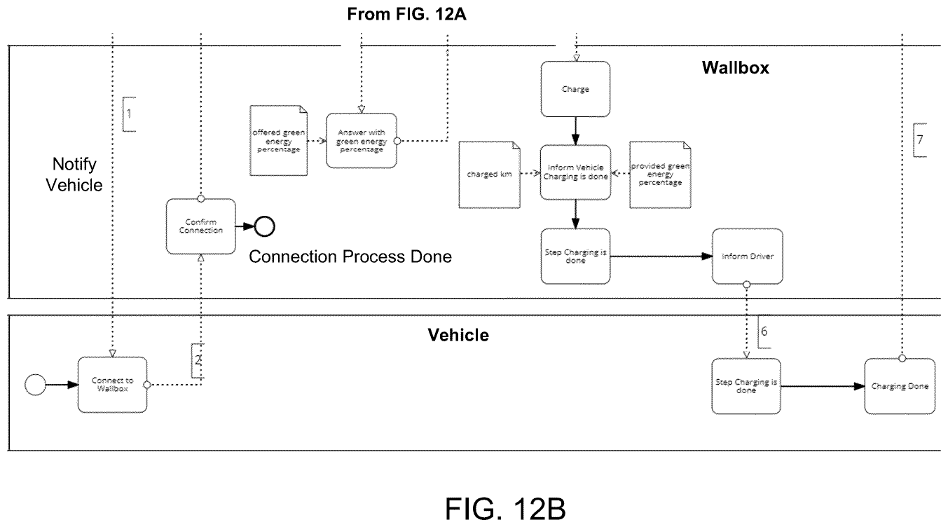

FIGS. 12A-B are diagrams showing the interactions involved in this second example. The numbers 1 to 7 indicate Message Flows in this process. The three parties are:
a) the driver (“Heinz Becker”)—using an application,
b) the wallbox (“wallbox01”), and
c) the vehicle (“TeslaX”).

In summary, for FIGS. 12A-B the driver first connects the vehicle to the wallbox. The wallbox then shows the driver the percentage of green energy which is currently available. The driver approves the charging, and the vehicle is charged.

The wallbox informs the driver that the charging is completed. The driver disconnects the vehicle from the wallbox.

In this second example the H-Broker again acts like a man-in-the-middle. The parties interact with the H-Broker, and the H-Broker stores interactions and sets a timestamp for each interaction.

Details regarding the message flows 1-7 of FIGS. 12A-B marking interactions between the parties, are now discussed. The public Key Owner is shown in each transaction.

1: Driver to Vehicle

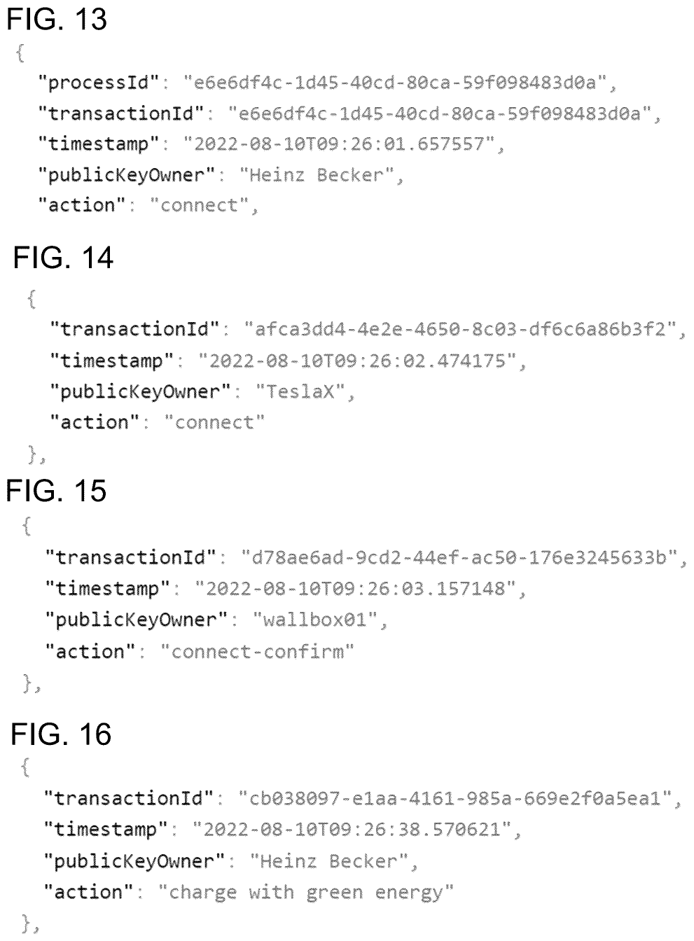

The first H-Broker transaction is created by the Driver. This define the process with the process id being the H-Broker Id. This is shown in FIG. 13.

2: Vehicle to Wallbox

The vehicle creates the transaction for the wallbox connection. This is shown in FIG. 14. The wallbox confirms the connection. This is shown in FIG. 15.

3: Driver to Wallbox

The driver tells the wallbox that the would like to charge his vehicle with green energy. This is shown in FIG. 16.

4: Wallbox to Driver

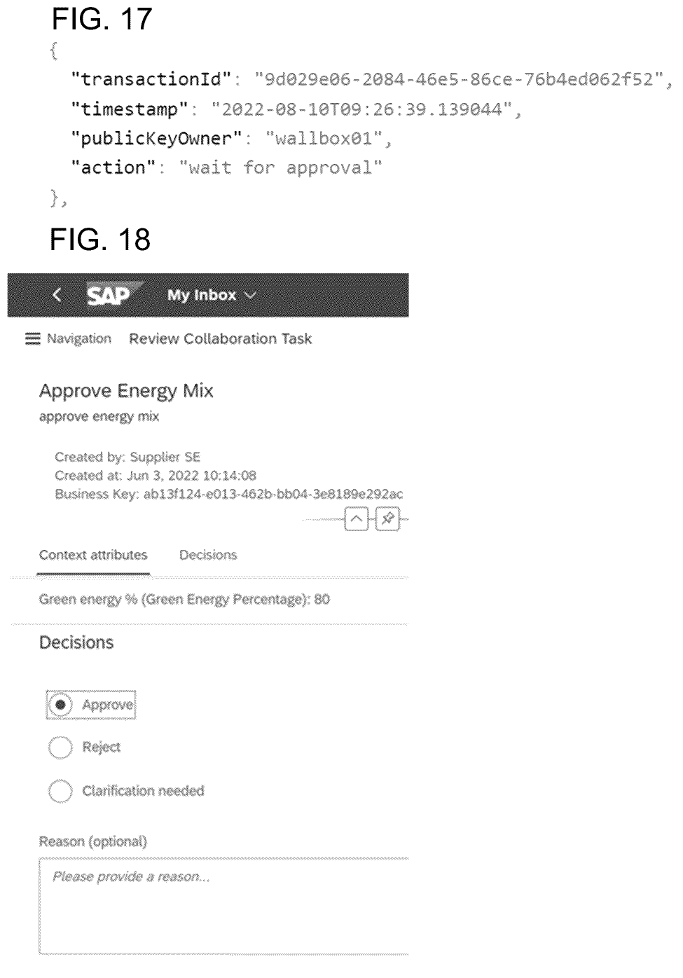

The wallbox informs the driver about the available green energy percentage. This is shown in FIG. 17.

FIG. 18 shows a screen shot of a sample Workflow Inbox of the driver, where he can approve or reject the offered green energy percentage. In this second example, the driver has selected “Approve”.

5: Driver to Wallbox

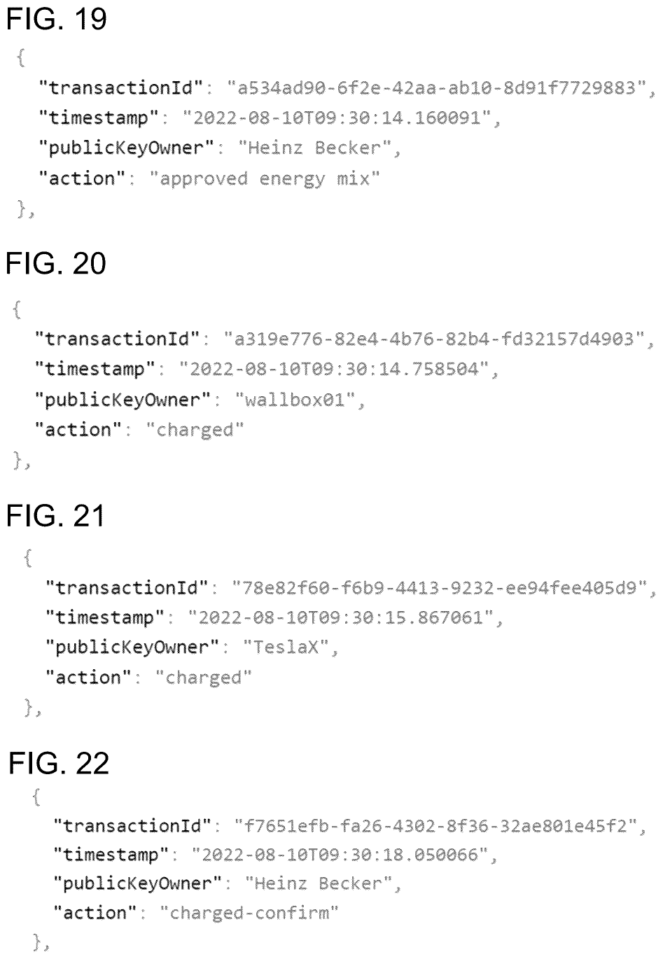

The driver approves the energy mix. This is shown in FIG. 19.

6: Wallbox to Vehicle

The wallbox (wallbox01) has charged the vehicle. This is shown in FIG. 20.

7: Vehicle to Driver

The vehicle (TeslaX) creates a transaction to confirm the charging by the wallbox. This is shown in FIG. 21.

The driver confirms the entire charging process. This is shown in FIG. 22.

The complete charging process according to this second example, is logged as Blockchain transactions by the H-Broker. These transactions can be used, e.g., to create an invoice for the driver.

Moreover, the transactions can also be used to perform analytics. One example of an analytic could result from querying: “All charging processes done by a specific wallbox”.

Returning now to FIG. 1, there the particular embodiment is depicted with the interface engine as being located outside of the database. However, this is not required.

Rather, alternative embodiments could leverage the processing power of an in-memory database engine (e.g., the in-memory database engine of the HANA in-memory database available from SAP SE), in order to perform various functions as described above.

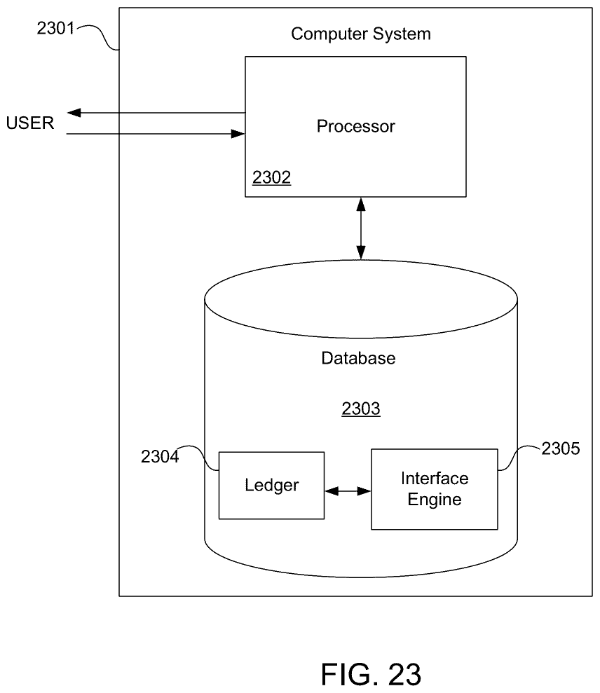

Thus FIG. 23 illustrates hardware of a special purpose computing machine configured to implement a communications interface according to an embodiment. In particular, computer system 2301 comprises a processor 2302 that is in electronic communication with a non-transitory computer-readable storage medium comprising a database 2303. This computer-readable storage medium has stored thereon code 2305 corresponding to an interface engine. Code 2304 corresponds to a ledger. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1. Computer implemented system and methods comprising:
a first system receiving an instruction to communicate content across a system boundary;
in response to the instruction, the first system generating a ledger entry comprising a timestamp and a first key;
the first system storing the content and the ledger entry as a message in a non-transitory computer readable storage medium; and
the first system communicating the message across the system boundary.

Example 2. The computer implemented system and method of Example 1 wherein the system boundary comprises a firewall.

Example 3. The computer implemented system and method of Examples 1 or 2 wherein the ledger entry comprises a blockchain transaction of a blockchain.

Example 4. The computer implemented system and method of Examples 1, 2, or 3 wherein generating the ledger entry further comprises:

creating a link with an existing ledger entry including an earlier timestamp and previously received from a second system across the system boundary.

Example 5. The computer implemented system and method of Example 4 wherein the link comprises a one-way hash.

Example 6. The computer implemented system and method of Example 1, 2, 3, 4, or 5 wherein the message further comprises an identifier of an interaction flow.

Example 7. The computer implemented system and method of Examples 1, 2, 3, 4, 5, or 6 wherein the non-transitory computer readable storage medium comprises an in-memory database.

Example 8. The computer implemented system and method of Example 7 wherein an in-memory database engine of the in-memory database creates the link.

Example 9. The computer implemented system and method of Example 7 wherein an in-memory database engine of the in-memory database generates the ledger entry.

Example 10. The computer implemented system and method of Example 7 wherein an in-memory database engine of the in-memory database creates the content.

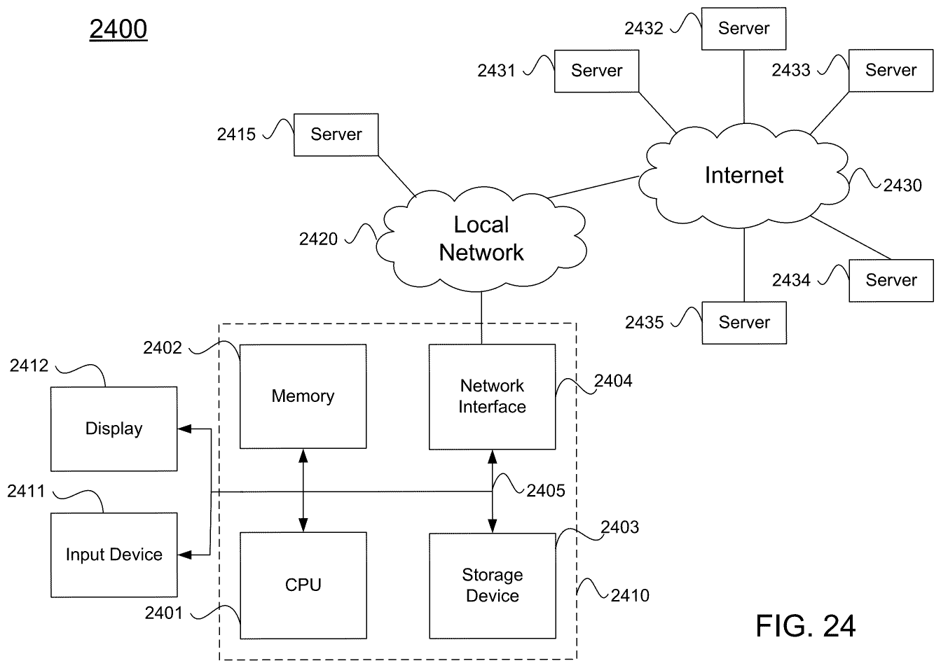

An example computer system 2400 is illustrated in FIG. 24. Computer system 2410 includes a bus 2405 or other communication mechanism for communicating information, and a processor 2401 coupled with bus 2405 for processing information. Computer system 2410 also includes a memory 2402 coupled to bus 2405 for storing information and instructions to be executed by processor 2401, including information and instructions for performing the techniques described above, for example. This memory may also be used for storing variables or other intermediate information during execution of instructions to be executed by processor 2401. Possible implementations of this memory may be, but are not limited to, random access memory (RAM), read only memory (ROM), or both. A storage device 2403 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 2403 may include source code, binary code, or software files for performing the techniques above, for example. Storage device and memory are both examples of computer readable mediums.

Computer system 2410 may be coupled via bus 2405 to a display 2412, such as a Light Emitting Diode (LED) or liquid crystal display (LCD), for displaying information to a computer user. An input device 2411 such as a keyboard and/or mouse is coupled to bus 2405 for communicating information and command selections from the user to processor 2401. The combination of these components allows the user to communicate with the system. In some systems, bus 2405 may be divided into multiple specialized buses.

Computer system 2410 also includes a network interface 2404 coupled with bus 2405. Network interface 2404 may provide two-way data communication between computer system 2410 and the local network 2420. The network interface 2404 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 2404 sends and receives electrical, electromagnetic, or optical signals that carry digital data streams representing various types of information.

Computer system 2410 can send and receive information, including messages or other interface actions, through the network interface 2404 across a local network 2420, an Intranet, or the Internet 2430. For a local network, computer system 2410 may communicate with a plurality of other computer machines, such as server 2415. Accordingly, computer system 2410 and server computer systems represented by server 2415 may form a cloud computing network, which may be programmed with processes described herein. In the Internet example, software components or services may reside on multiple different computer systems 2410 or servers 2431-2435 across the network. The processes described above may be implemented on one or more servers, for example. A server 2431 may transmit actions or messages from one component, through Internet 2430, local network 2420, and network interface 1604 to a component on computer system 2410. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

1. A method comprising:
a first system initiating a first interaction flow and receiving an instruction to communicate content across a system boundary with a second system performing a second interaction flow complementary to the first interaction flow, wherein the first and second interaction flows are cross-system processes each comprising a plurality of process steps;
in response to the instruction and for each process step of the first interaction flow, the first system generating first ledger entries of a blockchain comprising content corresponding to a particular process step, unique timestamps, and unique keys,
the first system communicating the content across the system boundary to the second system through the blockchain; and
in response to the content from the first system and for each process step of the second interaction flow, the second system generating second ledger entries of the blockchain comprising content corresponding to a particular process step of the second interaction flow, the unique time stamps, and the unique keys, the second system communicating second content to the first system through the blockchain,
wherein the blockchain is a distributed storage platform comprising individual distributed computing devices connected in a chain.

2. The method as in claim 1 wherein the system boundary comprises a firewall.

3. The method as in claim 1 wherein the first ledger entries of the blockchain comprise a blockchain transaction.

4. (canceled)

5. The method as in claim 1 wherein the blockchain comprises a one-way hash.

6. (canceled)

7. The method as in claim 1 wherein the content further comprises an identifier of the interaction flow.

8. (canceled)

9. The method as in claim 1 wherein an in-memory database engine creates the content.

10. A non-transitory computer readable storage medium embodying a computer program for performing a method, said method comprising:
a first system initiating a first interaction flow and receiving an instruction to communicate content across a system boundary with a second system performing a second interaction flow complementary to the first interaction flow, wherein the first and second interaction flows are cross-system processes each comprising a plurality of process steps;
in response to the instruction and for each process step of the first interaction flow, the first system generating first ledger entries of a blockchain comprising content corresponding to a particular process step, unique timestamps, and unique keys,
the first system communicating the content across the system boundary to the second system through the blockchain;
in response to the content from the first system and for each process step of the second interaction flow, the second system generating second ledger entries of the blockchain comprising content corresponding to a particular process step of the second interaction flow, the unique time stamps, and the unique keys, the second system communicating second content to the first system through the blockchain,
wherein the blockchain is a distributed storage platform comprising individual distributed computing devices connected in a chain.

11. The non-transitory computer readable storage medium as in claim 10 wherein the blockchain comprises a one-way hash.

12. (canceled)

13. The non-transitory computer readable storage medium as in claim 10 wherein the system boundary comprises a firewall.

14. The non-transitory computer readable storage medium as in claim 10 wherein the content further comprises an identifier of the interaction flow.

15. A computer system comprising:
one or more processors;
a software program, executable on said computer system, the software program configured to cause an in-memory database engine of an in-memory database of a first system to:
initiate a first interaction flow and receive an instruction to communicate content across a system boundary to a second system through a blockchain, the second system configured to perform a second interaction flow complementary to the first interaction flow, wherein the first and second interaction flows are cross-system processes each comprising a plurality of process steps;
in response to the instruction and for each process step of the first interaction flow, the first system configured to generate first ledger entries of the blockchain comprising unique timestamps and unique first keys; and
in response to the content from the first system and for each process step of the second interaction flow, the second system is configured to generate second ledger entries of the blockchain comprising content corresponding to a particular process step of the second interaction flow, the unique time stamps, and the unique keys, the second system configured to communicate second content across to the first system through the blockchain,
wherein the blockchain is a distributed storage platform comprising individual distributed computing devices connected in a chain.

16. The computer system as in claim 15 wherein the system boundary comprises a firewall.

17. (canceled)

18. The computer system as in claim 17 wherein the blockchain comprises a one-way hash.

19. (canceled)

20. The computer system as in claim 15 wherein the in-memory database engine is further configured to create the content.
